(19) United States
(12) Patent Application Publication
(10) Pub. No.: US 2005/0182356 A1
(43) Pub. Date: Aug. 18, 2005

(54) Drinking apparatus for fluid management of dialysis patients

(76) Inventor: Eric M. Dixon, Alexandria, VA (US)

Correspondence Address: ROBERT PLATT BELL, REGISTERED PATENT ATTORNEY, 8033 WASHINGTON ROAD, ALEXANDRIA, VA, 22308, US

(21) Appl. No.: 10/778,827

(22) Filed: Feb. 17, 2004

(51) Int. Cl. A61J 7/00

(52) U.S. Cl. 604/77; 600/300

(57) ABSTRACT

A drinking apparatus for measuring and managing fluid intake is disclosed. The drinking apparatus includes a straw or intake tube for the user to draw fluid. A flow sensor is attached in-line to the straw for measuring the fluid flow rate. An electronic microprocessor is connected to the flow sensor to convert the flow rate to volume. A display enables the patient to view the total amount of liquid consumed and set threshold amounts. A total amount of fluid (volume) can be set as an alarm threshold. A user sucking on the system may actuate the drinking apparatus.

### FIELD OF THE INVENTION

This invention relates generally to a drinking apparatus and more particularly to a fluid management system for enabling a dialysis patient or athlete to manage fluid intake.

### BACKGROUND OF THE INVENTION

Fluid and electrolyte balance in the body plays a large role in all of our lives. Fluid balance or the state in which the amount of fluid leaving the body (in form of urine, sweat, vomiting, etc) is equal to the fluid entering the body (in form of food, drink, intravenous fluid, dialysis fluid, etc) is important and has to be managed properly for humans to function. There are conditions where either the body is unable to manage these fluid balances or it needs intervention to keep up with losses.

A dialysis patient does not have the kidney function to properly remove all fluids from his/her body. Hemodialysis is usually performed at a clinic three or more times a week. During the days between treatments (interdialysis time), a patient is expected to manage what he/she drinks (limited to 1400 cc per day). If patient fluid management is poor, excess fluids build up in a patient's blood. The consequences of fluid abuse can include systemic and cardiovascular issues and are a frequent clinic complication of hemodialysis patients. Management of fluid intake becomes paramount under these conditions.

For dialysis patients, written materials are often given to the patient to read that discuss proper fluid intake. The National Kidney Foundation has online brochures discussing fluid issues. Other ideas such as limiting table salt and high sodium foods, sucking ice cubes, and using lemon wedges are offered to help patients. It is also suggested that patients carry a delineated cup or bottle that may keep track of the amount of fluid the patient drinks. While well meaning, the above-described conventional management techniques have not help stem the tide of fluid overload in the dialysis community. No known device or system has addressed the problem of the managing fluid intake.

In athletes, consuming sufficient fluid is a concern, which is just the opposite of the concerns of a dialysis patient. Unless sweat losses are replaced during exercise, an athlete will become dehydrated. Severe levels of dehydration have a dramatic effect on exercise performance. But even small fluid losses reduce performance and increase an athlete's feeling of effort. A sufficient fluid intake is a crucial part of any athlete's competition strategy. Being able to manage and measure fluid intake over time would go far in increasing an athlete's performance.

In view of the above, it is apparent that there exists a need in the art for a drinking apparatus which is capable of assisting a user or patient in managing fluid intake.

### SUMMARY OF THE INVENTION

The present invention provides highly accurate methods and systems of measuring fluid intake of a user through a drinking apparatus. According to the present invention, fluid intake is determined by the amount of fluid that is ingested through the apparatus of the present invention. A flow sensor in the apparatus calculates the fluid flow. The rate is converted to volume, displayed and saved as an accumulated volumetric total. If the fluid throughput volume exceeds the alarm threshold set, audible and visual alarms may be generated.

One embodiment of the present invention provides a method for measuring fluid intake of a user. This method comprises steps of allowing fluid through the drinking apparatus; measuring the fluid using a flow sensor; displaying the volumes; and signaling by audio and/or visual signals when an amount of fluid measured exceeds the set threshold value set by the user.

In view of the foregoing, it is an object of the present invention to provide the user a fluid management drinking apparatus that measures, stores and displays user fluid intake over a period of time.

A further object of the present invention is to provide the user with accumulated fluid volume measurements as the user drinks.

A further object of the present invention is to provide a system which may accommodate a variety of fluids having various volumes, concentrations, viscosities, and the like.

A further object of the present invention is to provide a system which may allow sections of the drinking apparatus to be disposable.

A further object of the present invention is to alert the user when a predetermined fluid volume limit has been reached.

Other features and advantages of the present invention will become readily apparent upon a perusal of the following description and the accompanying drawings.

### BRIEF DESCRIPTION OF THE DRAWINGS

FIG. 1 is a top or plan view of the fluid management drinking apparatus in accordance with a preferred embodiment of the present invention;

FIG. 2 is a side view of the fluid management drinking apparatus in accordance with a preferred embodiment of the present invention;

FIG. 3 is a block schematic of the fluid management drinking apparatus in accordance with a preferred embodiment of the present invention;

### DETAILED DESCRIPTION OF THE INVENTION

While this invention is susceptible of embodiment in many forms, there is illustrated in the drawings, and will be described in detail herein, a preferred embodiment, with the understanding that the present disclosure is to be considered an example of the principles of the invention and is not intended to limit the invention to the preferred embodiment illustrated.

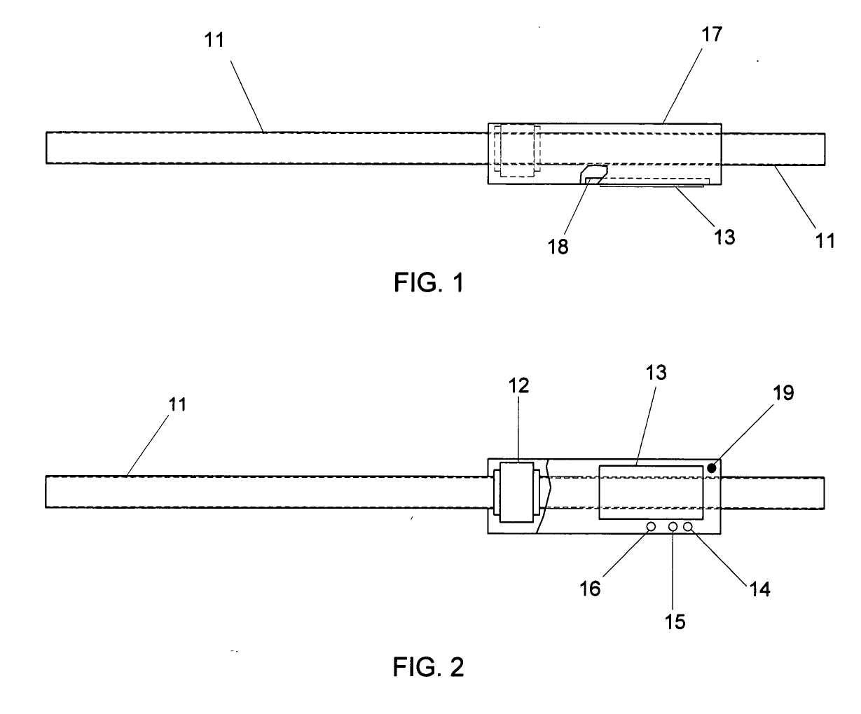

Referring to FIG. 1, main straw body 11 runs through the length of the drinking apparatus enabling the user to draw fluid. Flow sensor 12 is positioned in line of main straw body 11 to measure fluid flow rate through main straw body 11. LCD display 13 and LED 19 are connected to micro-controller 18 which is housed in enclosure 17 along with a power supply 20 (e.g., battery, not shown).

Power supply 20 provides power to micro-controller 18 and flow sensor 12. Micro-controller 18 is connected to and receives signals from flow sensor 12.

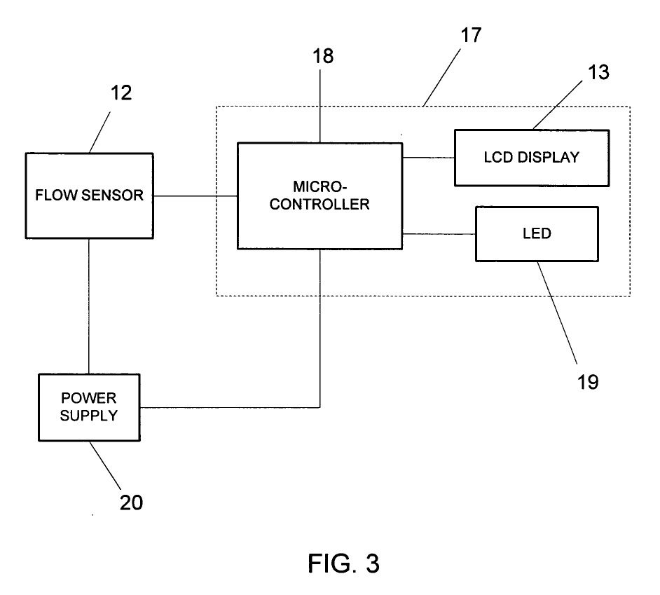

FIG. 3 depicts the component interconnections between the micro-controller 18 the flow sensor 12 and the power supply 20 (e.g., battery). The various components illustrated in FIG. 3 are known to those of ordinary skill in the art.

Referring back to FIG. 2, micro-controller 18 has an on/off switch 16, a reset switch 15 and a high fluid limit switch 14 accessible through enclosure 17. On/off switch 16 turns the drinking apparatus on and off. Reset switch 15 allows a user to set the accumulated volume stored in micro-controller 18 to zero. High fluid limit switch 14 allows a user to set a volume limit for which the device will alarm if reached.

In an alternative embodiment of the subject invention, a light bar is integrated into enclosure 17 to indicate volume instead of a LCD display 13.

In another alternative embodiment of the present invention, main straw body 11 may be integrated with a lid designed to fit numerous sized drinking cups or bottles.

In operation, the user resets the drinking apparatus using the reset switch 15 to zero and optionally sets a volume limit with the high fluid limit switch 14.

In use, the user sucks on straw 11 to turn the drinking apparatus “ON” or alternately uses the on/off switch 16. Flow sensor 12 measures the flow of fluid through straw 11, and micro-controller 18, converts the flow signal to volume and adds the measured volume flow to a stored volume, (if any) and displays the cumulative volume on display 13.

If the user exceeds a predetermined threshold setting, the device may alert the user via LED 19 or by an audible alarm.

When the user stops drinking, the apparatus concatenates the recent volume to previously stored volume, displays the result for 5 seconds on display 12, then turns “OFF”. Alternately, the user may switch off the unit via on/off switch 16. Total volumes are stored in the micro-controller 18 until reset. LED 19 may be lit if the total volume consumed exceeds the limit set by the user.

While the above is a complete description of the preferred embodiments of the invention, various alternatives, modifications and equivalents may be used. It should be evident that the present invention is equally applicable by making appropriate modifications to the embodiments described above. Therefore, the above description should not be taken as limiting the scope of the invention which is defined by the metes and bounds of the appended claims.

1. An apparatus for managing fluid intake of a user, said apparatus comprising:
a tube through which the user drinks a fluid;
a flow sensor connected in line to the tube for measuring fluid flow through the tube;
a micro-controller, coupled to the flow sensor, for converting flow rate measured by the flow sensor to fluid volume and for saving the fluid volume; and
a display, coupled to the micro-controller, for displaying current and total volume of fluid the user has ingested over a period of time.

2. The apparatus of claim 1, wherein the display further comprises:
means for displaying whether the total volume ingested has crossed a predetermined threshold fluid amount.

3. The apparatus of claim 2, wherein said display includes means for alerting a user when the total volume ingested crosses the predetermined threshold fluid amount.

4. The apparatus of claim 3, further comprising means for alerting the user by at least one of audible and visual signals if the total volume ingested crosses the predetermined threshold fluid amount.

5. The apparatus of claim 1 wherein the micro-controller further includes at least one memory for storing the total volume of fluid ingested value and for storing software to enable the device to display information.

6. The apparatus of claim 5, further comprising means for setting the predetermined threshold fluid amount.

7. The apparatus of claim 6 further comprising means for resetting the total fluid ingested value stored in the micro-controller.

8. The apparatus of claim 7, wherein the visual signal comprises a flashing LED signal.

9. The apparatus of claim 8, wherein the apparatus is activated and deactivated based upon flow through the flow sensor.

10. The apparatus of claim 9, wherein the display comprises a light bar for displaying total volume ingested as a plurality of light elements on the light bar.

11. A method for measuring fluid intake comprising the steps of:
drinking a fluid through a tube provided with a flow sensor connected in line to the tube,
measuring fluid flow through the tube with the flow sensor,
converting, using a micro-controller, flow rate measured by the flow sensor to fluid volume,
saving the fluid volume value, and
displaying in a display coupled to the micro-controller, current and total volume of fluid the user has ingested over a period of time.

12. The method of claim 11, wherein the step of displaying further comprises the step of displaying whether the total volume ingested has crossed a predetermined threshold fluid amount.

13. The method of claim 12, wherein the step of displaying includes the step of alerting a user when the total volume ingested crosses the predetermined threshold fluid amount.

14. The method of claim 13, further comprising the step of alerting the user by at least one of audible and visual signals if the total volume ingested crosses the predetermined threshold fluid amount.

15. The method of claim 14, wherein the step of saving the fluid volume value comprises the step of storing in at least one memory coupled to the micro-controller, the total volume of fluid ingested value.

16. The method of claim 15, further comprising the step of setting the predetermined threshold fluid amount.

17. The method of claim 16 further comprising the step of resetting the total fluid ingested value stored in the micro-controller after a predetermined time period has elapsed.

18. The method of claim 17, wherein the visual signal comprises a flashing LED signal.

19. The method of claim 11, further comprising the step of activating and deactivating the apparatus based upon flow through the flow sensor.

20. The method of claim 11, wherein the step of displaying comprises the step of displaying, on a light bar, total volume ingested as a plurality of light elements on the light bar.
